(19) United States
(12) Patent Application Publication
(10) Pub. No.: US 2013/0151013 A1
(43) Pub. Date: Jun. 13, 2013

(54) Method for Controlling HVAC Systems Using Set-Point Trajectories

(71) Applicants: Daniel Nikolaev Nikovski, Brookline, MA (US); Jingyang Xu, Malden, MA (US)

(72) Inventors: Daniel Nikolaev Nikovski, Brookline, MA (US); Jingyang Xu, Malden, MA (US)

(21) Appl. No.: 13/324,140

(22) Filed: Dec. 13, 2011

(51) Int. Cl. G05D 23/19

(52) U.S. Cl. 700/276

(57) ABSTRACT

A method controls a heating, ventilation air conditioning (HVAC) system for a building. The system is modeled with a state space, wherein the state space includes a set of states and a corresponding action for each state, wherein the system changes from a current state to a next state based the current state, and a selected action. A set of samples is selected in the state space, and triangulated to descritize the state space into simplices, wherein each simplex has a set of nodes. For each state and a corresponding simplex, a value for each node is obtained, and then a trajectory of set-points of temperatures for the system is generated based on the values.

### FIELD OF THE INVENTION

This invention relates generally to heating, ventilation, and air conditioning (HVAC) systems, and more particularly to controlling HVAC systems to reduce energy consumption.

### BACKGROUND OF THE INVENTION

It is important to a control heating, ventilation, and air conditioning (HVAC) system so that energy consumption can be reduced. To control the HVAC system, outside and inside conditions are considered. The outside conditions can be due to the time of day, the seasons, and weather, and the inside condition can be due to the time of day, the day of the week, machinery, office equipment, lighting, occupants, and building thermal mass. All these conditions vary dynamically, and often in an unpredictable manner.

Therefore, HVAC system typically use input signals from timers, and sensors inside and outside of the building to determine heating, ventilation, and cooling demands relative to temperature set-points. Over time, the set-points form a trajectory. Generally, the object is to determine on optimal trajectory of set-points, which maintains a comfortable temperature, while reducing energy consumption.

One control strategy is Night Set-up Strategy (NSS). With this strategy, the HVAC system is used only when needed. The system is turned off at night as much as possible, using set-points for the heating systems, which are reduced at night in the winter. The set-points for the cooling systems are increased at night in the summer. The set-points are selected such that the system can essentially be turned off except when set-points are exceeded.

A number of methods for solving this problem are known, such as, dynamic optimization, genetic algorithms, and nonlinear optimization. However, those methods simulate using a generalized building thermal model. Some methods rely on an approximated model that does not have any guarantee on the performance of the system.

### SUMMARY OF THE INVENTION

The embodiments of the invention provide a method for controlling a heating, ventilation, and air conditioning (HVAC) system to reduce energy consumption. The method uses a Markov decision problem (MDP), and associated solving techniques.

A building thermal model is converted to an MDP model, after using Delaunay triangulation, and action discretization.

Specifically, a method controls a heating, ventilation, and air conditioning (HVAC) system for a building. The system is modeled with a state space model, wherein the state space includes a set of states. A set of suitable actions is defined for each state, wherein the system changes from a current state to a next state based on the current state, and a selected action.

A set of samples is selected in the state space, and triangulated to descritize the state space into simplices, wherein each simplex has a set of nodes. For each state and a corresponding simplex, a cost-to-go for each node is obtained, and then a trajectory of set-points of temperatures for the system is generated based on the computed costs-to-go.

### BRIEF DESCRIPTION OF THE DRAWINGS

FIG. 1 is a schematic of a Denaulay triangulation used by embodiments of the invention;

FIG. 2 is a schematic of a process for changing state spaces according to embodiments of the invention;

FIG. 3 is a flow diagram of a method for reducing energy consumption in an HVAC system according to embodiments of the invention; and

FIG. 4 is an example thermal circuit representing building thermal dynamics to be converted to a Markov decision process (MDP) according to embodiments of the invention.

### DETAILED DESCRIPTION OF THE PREFERRED EMBODIMENT

The embodiments of our invention provide a method for controlling a heating, ventilation, and air conditioning (HVAC) system in a building to reduce energy consumption. More specifically, we use a Markov decision process (MDP) to solve this problem.

Markov Decision Problem Model for Optimizing Set-Point Trajectories

Introduction to MDP

MDP provides a framework for solving sequential decision problems. A typical MDP for a system has a set of states and corresponding sets of actions for each state. The system changes from a current state to a next state based on the current state, and a selected action. In another word, the transition process of MDP is memoryless. For example, the current state of a component the system is OFF, the action is TURN ON, and the next state is ON, or a component has a current state of 21°, and the action is INCREASE 5°, and in the next state the component operates at 26°. It is noted, that buildings are often partitioned into zones, and the heating, ventilation air conditioning in the zones are controlled independently.

For a pair of state and action, the next state is not deterministic, usually with probabilities to a number of states. These properties of MDP make a useful framework for modeling dynamic systems and decision processes.

A description for a common finite MDP is a four-tuple of (I; X, U, P), where:
T is a set of time instances along a time interval, where T={1, . . . , |T|};
t is the index for time steps, where tεT
X is a set of states, where X={x₁, . . . , x_{|X|}};
U is a set of actions, where U={u₁, . . . , u_{|U|}};
pᵢⱼ(u) is a probability that the system transitions from state i to j when action u is selected;
pᵢⱼ(u) has properties such that:

$$\begin{matrix}0 \leq {p}_{ij} ( u ) \leq 1 , ∀ {x}_{i} , {x}_{j} ∈ X , u ∈ U , & ( 1 ) \\ {\sum }_{∀ {x}_{j} ∈ X} {p}_{ij} ( u ) = 1 , ∀ {x}_{i} ∈ X , u ∈ U . & ( 2 )\end{matrix}$$

P is the set of state transition conditional probabilities, where

P={pᵢⱼ(u)|∀xᵢ,xⱼεX,uεU}.
R is a cost function such that R(u, x, 1) corresponds to the cost of selecting action u at state x at time t. Since we are getting different energy costs when operating an HVAC system, we actually want to minimize R along the entire time horizon;
f(x, u) is a solution to the MDP that gives pair of action and state as decisions;
Vₜ is an optimal total cost-to-go at time/stage t in the MDP, counted until the end of the decision horizon T; and by Bellman's principle of optimality, is computed as

$$\begin{matrix}{V}_{t} ( {x}_{i} ) = {min}_{∀ u ∈ U} \{ R ( {x}_{i} , u ) + {\sum }_{∀ {x}_{j} ∈ X} {p}_{ij} ( u ) {V}_{t + 1} ( {x}_{j} ) \} , \\ ∀ {x}_{i} ∈ X , 1 \leq t \leq \vert T \vert - 1 , & ( 3 ) \\ {V}_{\vert T \vert} = {min}_{∀ u ∈ U , {x}_{i} ∈ X} R ( {x}_{i} , u , \vert T \vert ) . & ( 4 )\end{matrix}$$

The MDP is solved using backward dynamic programming when the time interval T is finite, and by value iteration or policy iteration when the time interval T is infinite.

Building Thermal Model

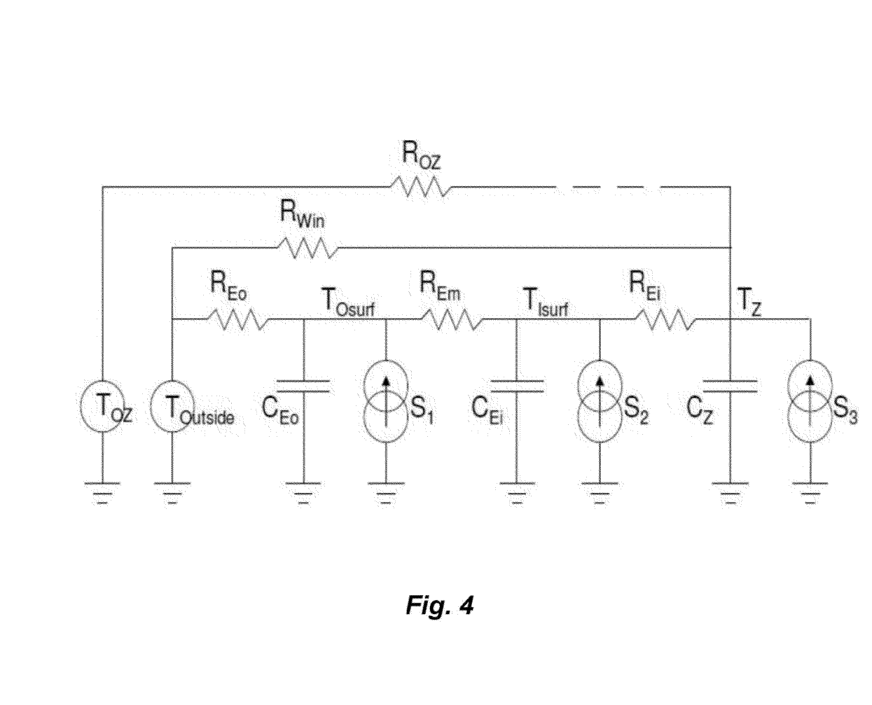

The MDP based trajectory is generated and simulated via an example thermal circuit as shown in FIG. 4 with parameter settings of Table

TABLE 1

| Parameter | Parameter |
|---|---|
| Name | Value |
| R_{Oz} | 0 |
| R_{Win} | 0.1295 |
| R_{Eo} | 0.3846 |
| R_{Em} | 0.0511 |
| R_{Ei} | 0.0261 |
| C_{Eo} | 7.3447e+05 |
| C_{Ei} | 9.5709e+05 |
| C_{Z} | 9.3473e+04 |

where R_{Oz} is the thermal resistance between an office zone and other zones, R_{Win} is the resistance between thee office zone and an outside environment through windows, R_{Eo} is the thermal resistance of the outside wall surface, C_{Eo} is the thermal capacitance of outside wall surface, R_{Em} is the thermal resistance between the outside wall surface and an inner wall surface, C_{Ei} is the thermal resistance of the inner wall surface, R_{Ei} is the thermal resistance between the inner wall surface and zone capacitance, C_{Z} is the thermal capacitance of zone, and T_{Z} is the zone temperature.

Continuous State Continuous Action MDP

The MDP problem could be solved with equations (1) to (4) using backward dynamic programming. However, in the HVAC control problem, the temperature values at every capacitance in the thermal circuit are in a continuous interval instead of a discrete set. The situation is the same for actions, as the actions determine the temperatures, which are also continuous.

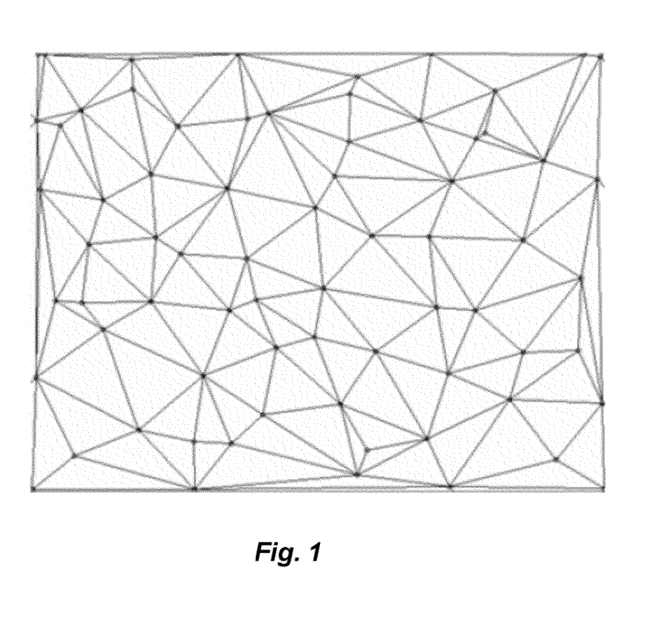

Thus, to make the discrete dynamic programming framework applicable for solving this problem, discretization is needed for both temperatures and actions. Terminologies and notations used are listed as follows:
In geometry, a simplex is a generalization of a triangle or tetrahedron to arbitrary dimension. Specifically, an n-simplex is an n-dimensional polytope with n+1 nodes, of which the simplex is the convex hull.
N is the dimension of a state space for the model, which is determined by the thermal circuit used. For example, FIG. 1 corresponds to a three dimension state space because it has three temperature values for determining the state of the building.
S is the set of all simplices, where S={s₁, s₂, . . . , s_{|S|}}.
For every state xᵢ, there is a corresponding value Vₜ(xᵢ) for being in that state at time step t.
For a state x and a simplex s in which x belongs, there are nodes x₁, . . . , x_{N}, for the simplex, and d₁, . . . , d_{N} are distances from x to x₁, . . . , x_{N+1}, respectively.

We apply Delaunay triangulation to the set of samples of the state space to descritize the state space into simplices. Each simplex has a set of nodes in the state space, where the number of nodes is 1+N. Thus, every state within the continuous state space belongs to one and only one simplex.

FIG. 1 shows an example 2D Delaunay triangulation.

For a state x and the corresponding simplex s including the nodes, equation (5) is applied for obtaining V(x) for values of the nodes in the simplex, where

$${V}_{t} ( x ) = {\sum }_{i = 1}^{N + 1} \frac{{d}_{i} {V}_{t} ( {x}_{i} )}{{\sum }_{i = 1}^{N + 1} {d}_{i}} , ∀ t ∈ T \qquad ( 5 )$$

The action is discretized into different levels. For example, if a comfort temperature range is [21° C.-26° C.], then actions for the set-points can be 21°, 22°, . . . , 26°, depending on the required accuracy.

Another special situation for the problem is that the outside temperature is changing, which leads to changing AC coefficient of performance (COP) values, and building thermal behavior. Thus, the time interval also needs to be discretized.

The same set of state spaces exists at every time step and the system state changes from the current state to the next state in the next time step.

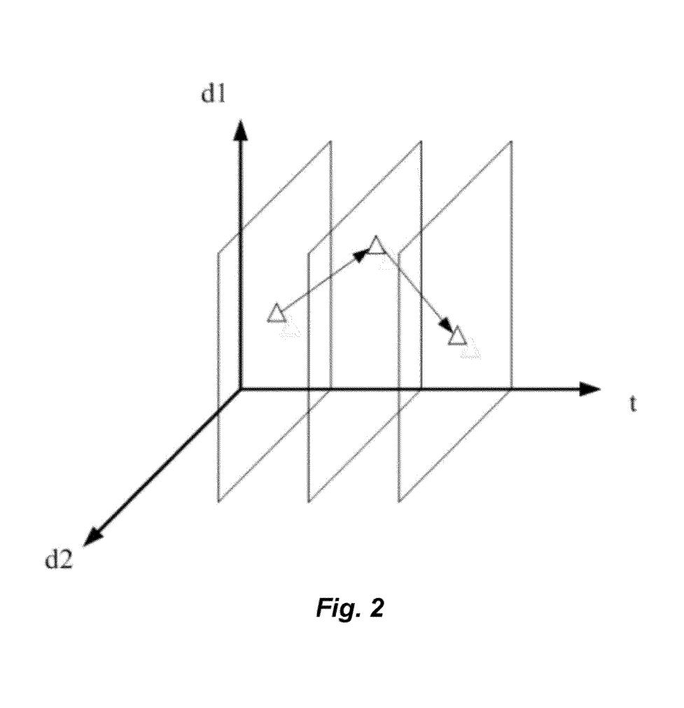

FIG. 2 shows a 2D example for this process for dimensions d1 and d2, with time (t) along the horizontal axes. When considering the changing COP along the time horizon, additional input variable of time factor is included in the decision making process. The recursive function for obtaining the value of the current state at current time instance is the following Bellman equation:

$${V}_{t} ( {x}_{i} ) = {min}_{∀ u ∈ U} \{ R ( {x}_{i} , u , t ) + {\sum }_{∀ {x}_{j} ∈ X} {p}_{ij} ( u , t ) {V}_{t + 1} ( {x}_{j} ) \} , \\ ∀ {x}_{i} ∈ X , t ∈ T , \qquad ( 6 )$$

The Bellman equation, also known as a dynamic programming equation, is a necessary condition for optimality in dynamic programming. The equation expresses the value of the decision problem at a certain instance in time in terms of the payoff from some initial choices, and the value of the remaining decision problem that results from those initial choices. This reduces a dynamic optimization problem to simpler subproblems.

Trajectory Generation Procedure

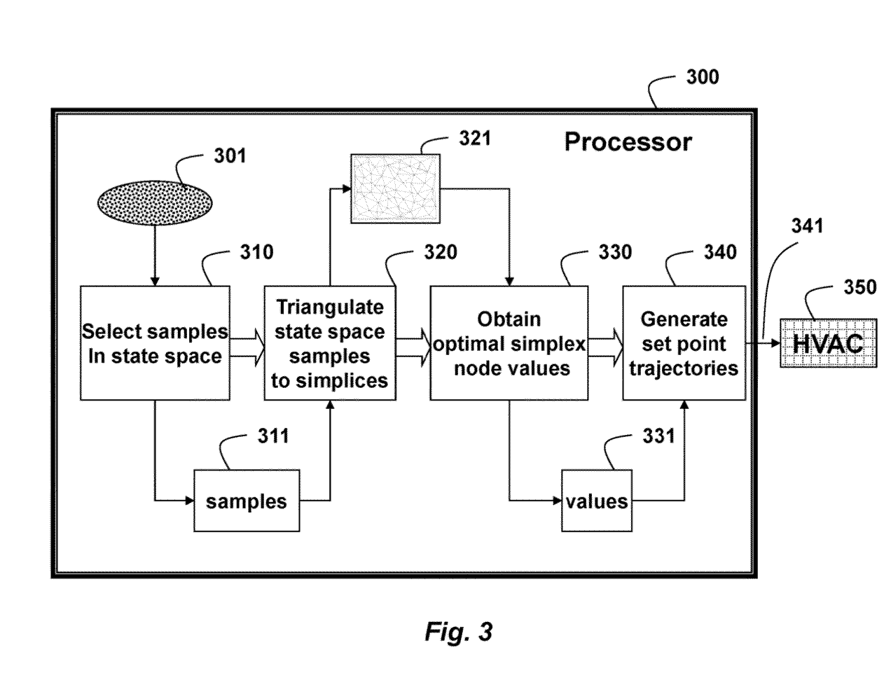

Thus, as shown in FIG. 3, we use the following method for generating the optimal set-point trajectory 341 to control the HVAC system 350. The method can be performed in a processor 300 connected to a memory and input/output interfaces as known in the art.

Sampling.

A set of samples 311 in the state space 301 is selected 310. There can be different ways of sampling. In one embodiment, we apply uniform sampling along each dimension, including boundary nodes make sure all states are covered by the simplices

State Space Triangulation.

Denaulay triangulation is applied 320 to the state space samples to descritize the state space into simplices, wherein each simplex has a set of nodes.

Simplex Node Optimal Value Evaluation.

A Bellman equation is applied to obtain 330 the optimal value of each node of every simplex.

### Effect of the Invention

The potential savings by applying MDP based trajectory can be greater than 50% when compared with conventional methods, such as NSS, which needs to be optimized every time when it is applied in a different environment.

In contrast, our MDP based approach can generate set-point trajectory adaptively to different outside weather and inside building thermal properties.

The process on state space triangulation and set-point trajectory generation can be parallelized.

Our MDP based approach yields a greatly changing trajectory, which is actually equivalent to trajectories that are smoother. This can be achieved by changing the order for evaluating different actions during the trajectory generating process.

To speed up the evaluation process for potential actions, a number of actions can be aggregated because the aggregated actions lead to same next state with same cost.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for controlling a system to reduce energy consumption, wherein the system is a heating, ventilation air conditioning (HVAC) system for a building, comprising the steps of:
modeling the system with a state space, wherein the state space includes a set of states and a corresponding actions for each state, wherein the system changes from a current state to a next state based the current state, and a selected action;
selecting a set of samples in the state space;
triangulate the set of samples of the state space to descritize the state space into simplices, wherein each simplex has a set of nodes;
obtaining, for each state and a corresponding simplex, a value for each node;
generating a trajectory of set-points of temperatures for the system based on the values, wherein the steps are performed in a processor.

2. The method of claim 1, wherein the controlling uses a Markov decision process (MDP).

3. The method of claim 2, wherein the MDP is finite, and further comprising:
describing the finite MDP by a four-tuple of (T, X, U, P), where:
T is a set of time instances along a time interval, where T={1, . . . , |T|};
X is the set of states, where ={xᵢ, . . . , x_{|X|}};
U is the set of actions, where U={u₁, . . . , u_{|U|}};
pᵢⱼ(u) is a probability that the system transitions from state i to j when action u is selected;
pᵢⱼ(u) has properties such that:
$$\begin{matrix}0 \leq {p}_{ij} ( u ) \leq 1 , ∀ {x}_{i} , {x}_{j} ∈ X , u ∈ U , & ( 1 ) \\ {\sum }_{∀ {x}_{j} ∈ X} {p}_{ij} ( u ) = 1 , ∀ {x}_{i} ∈ X , u ∈ U . & ( 2 )\end{matrix}$$
P is a set of state transition conditional probabilities, where
P={pᵢⱼ(u)|∀xᵢ,xⱼεX,uεU}.
R is a reward function such that R(u, x) corresponds to a benefit of selecting action u at state x;
f(x, u) is a solution to the MDP that gives a pair of action and state as decisions;
Vₙ, nεT is an optimal total reward at stage n in the MDP; and
$$\begin{matrix}{V}_{t} ( {x}_{i} ) = {min}_{∀ u ∈ U} \{ R ( {x}_{i} , u ) + {\sum }_{∀ {x}_{j} ∈ X} {p}_{ij} ( u ) {V}_{t + 1} ( {x}_{j} ) \} , \\ ∀ {x}_{i} ∈ X , 1 \leq t \leq \vert T \vert - 1 , & ( 3 ) \\ {V}_{\vert T \vert} = {min}_{∀ u ∈ U , {x}_{i} ∈ X} R ( {x}_{i} , u , \vert T \vert ) . & ( 4 )\end{matrix}$$

4. The method of claim 3, further comprising:
solving the MDP using backward dynamic programming when the time interval T is finite.

5. The method of claim 3, further comprising:
solving the MDP using value iteration or policy iteration when the time interval T is infinite.

6. The method of claim 1, further comprising:
discretizing the temperatures, and actions.

7. The method of claim 1, where the values V for each state x is
$${V}_{t} ( x ) = {\sum }_{i = 1}^{N + 1} \frac{{d}_{i} {V}_{t} ( {x}_{i} )}{{\sum }_{i = 1}^{N + 1} {d}_{i}} , ∀ t ∈ T \qquad ( 5 )$$
where N is a number of dimensions.

8. The method of claim 3, further comprising:
discretizing the time interval.

9. The method of claim 3, wherein the values of the current state at a current time is obtained according to
$${V}_{t} ( {x}_{i} ) = {min}_{∀ u ∈ U} \{ R ( {x}_{i} , u , t ) + {\sum }_{∀ {x}_{j} ∈ X} {p}_{ij} ( u , t ) {V}_{t + 1} ( {x}_{j} ) \} , \\ ∀ {x}_{i} ∈ X , t ∈ T , \qquad ( 6 )$$

10. The method of claim 1, wherein the sampling is uniform.
